(19) United States
(12) Patent Application Publication
(10) Pub. No.: US 2006/0019002 A1
(43) Pub. Date: Jan. 26, 2006

(54) Method for processing, storing and transporting garlic

(75) Inventor: Rui Tian Xue, Brooklyn, NY (US)

Correspondence Address: CROWELL & MORING LLP;INTELLECTUAL PROPERTY GROUP, P.O. BOX 14300, WASHINGTON, DC, 20044-4300, US

(73) Assignee: Harvest Food Co., Ltd., Brooklyn, NY (US)

(21) Appl. No.: 10/898,294

(22) Filed: Jul. 26, 2004

(51) Int. Cl. A23B 4/20

(52) U.S. Cl. 426/326

(57) ABSTRACT

Method for processing and packaging garlic, comprising selecting a garlic bulb comprising at least one clove, wherein the clove is contained within a membranous tunic, and has a stem end and a root end; removing the tunic from the glove thereon, to obtain a peeled garlic clove; cutting off a small fragment of the stem end of the clove; washing the peeled clove; surface-sterilizing the peeled clove; packaging the peeled clove in a plastic bag; and sealing the bag under vacuum. Also disclosed are an improved method for storing and transporting the processed garlic cloves, as well as the processed garlic cloves.

### FIELD OF THE INVENTION

The present invention generally relates to a method for storing fresh garlic and preserving the characteristics of fresh garlic, and to fresh garlic processed and packaged according to the method of the present invention.

### DESCRIPTION OF BACKGROUND ART

Garlic has been used as food, flavoring, and medicine all over the world for a long time. The famous French chef, X. Marcel Boulestin (1878-1943), is reputed to have said, “It is not really an exaggeration to say that peace and happiness begin, geographically, where garlic is used in cooking.” Garlic has a long and colorful history, with references in the Bible, in ancient Chinese writings, and in literary works by such luminaries as Shakespeare, Dante, and Sir Francis Bacon. Although used primarily today as a food flavoring agent and condiment, garlic has a history as a remedy for a wide variety of conditions and diseases. Thought to have originated in central Asia around Siberia, garlic was revered by both the ancient Egyptians and the Chinese. In the U.S., garlic is grown for its strong scented, pungent bulbs, although in some countries, the green tops are used in a manner similar to scallions

Research has shown garlic to have a host of positive health effects, including antiseptic qualities that have been credited to sulfur compounds in the cloves. The Chinese have long used garlic to reduce blood pressure and treat cardiovascular disease. Many medicinal effects are under study in the U.S.

Despite a flurry of research on garlic in the 1990's, much remains to be learned. Scientific and medical research continues worldwide on the health properties of various forms of garlic and garlic supplements. Health benefits ascribed to garlic and garlic supplements include: antibiotic/antifungal effects; antiseptic properties useful in fighting infections and dysentery-causing amoebas; antioxidant effects, protecting cells from free-radical damage and cancer; cholesterol reduction, lowering LDL and increasing HDL; natural anticoagulant properties, preventing blood clots and strokes; and anti-hypertensive effects, reducing blood pressure.

Documented medical research studies supporting the presence of these health benefits are numerous. A 1993 study at Pennsylvania State University found that garlic reduces triglycerides and cholesterol in livers and blood of laboratory rats. The Mayo Clinic reports that garlic is an effective blood thinner, reducing platelet clotting action. The clinic also states that garlic may reduce hypertension and help fight infection. Further, in a study involving more than 100,000 people, research released this year at the University of North Carolina found that eating one clove of raw or cooked garlic each day may reduce colon and stomach cancer. Allylic sulfides (found in garlic and onions) are considered by many researchers to be among the most potent of all nutrients from plants and may prevent some cancers and coronary disease. Further research is underway in institutions such as the Mayo Clinic, the Harvard Medical School, and the Cornell University Medical Center (which has a toll-free garlic hotline). In addition, the National Cancer Institute is funding research at Queen's University in Ontario on garlic's ability to shield lungs against chemical toxicants and potential carcinogens.

According to a USDA report, ever since garlic's introduction to the United States in the 1700s, its consumption of garlic has steadily increased. Many reasons underlie the increasing demand, reflecting a broadening view of garlic as a “functional food”—one that imparts both the usual taste and nutritional attributes of food, plus certain health-enhancing benefits. Used primarily in cooking to flavor a wide variety of foods, garlic provides vitamin C, potassium, phosphorous, selenium, amino acids, and a variety of sulfur compounds, including allicin.

Fresh garlic is overwhelmingly preferred by consumers because of its characteristic flavor, taste and texture. The most important ingredient contributing to the flavor and taste of fresh garlic is allicin. Allicin is formed only when fresh garlic is newly crushed, bringing the enzyme alliinase into contact with alliin. Because alliin and alliinase are stored separately in different compartments of a garlic clove, only after crushing a clove would the process of forming allicin be started. Allicin, however, does not last long as it dissipates within hours and becomes something else with a different taste.

Fresh garlic, however, is difficult to store. Garlic bulbs, although not as perishable as other fresh vegetables, will dry out or mold, or rot over time. Fresh garlic can be marketed for up to 3 months from the time of harvest with standard warehouse storage, up to 6 months if kept in cold storage, and up to a year under controlled atmosphere storage.

Although various methods of preserving garlic have been developed, such as freezing, drying, pickling, and preservation via cooking in oil, these methods often destroy the fresh garlic flavor, aroma, or texture. The various preservation process either destroys the enzyme or allicin, preventing the formation of allicin. As a consequence, preserved garlic has different taste and flavor.

Presently, garlic production is concentrated in certain parts of the world and the product is stored and shipped all over the world. This need for storage and shipping further shortens the usable or shell life of fresh garlic products.

Therefore, there is a need for an improved method for processing, storing and shipping fresh garlic that preserves the characteristics of fresh garlic.

In addition, the outer most leaf base of a garlic clove dries to form a cover called tunic or “skin.” Before consumption, the tunic needs to be removed as it is not edible. Removal of the tunic can be a nuisance for the consumer. Accordingly, it is desired that the fresh garlic is supplied as “peeled,” that is, without the skin or tunic.

### BRIEF DESCRIPTION OF THE DRAWINGS

FIG. 1 shows samples of vacuum packaged plastic bags containing processed garlic cloves according to the present invention.

### DESCRIPTION OF THE INVENTION

The present invention provides, in one embodiment, a method for storing and preserving fresh garlic bulbs whereby the freshness of the garlic is maintained for longer time period than conventional storage methods, including storage under refrigerated conditions.

The method of the present invention is suitable for all varieties of garlic bulbs, including single clove bulbs. The method of the present invention is suitable for all garlic varieties of the species Allium sativum, including the varieties under either of the two subspecies; Ophioscorodon (hard-necked garlic), and Sativum (soft-necked garlic). The hard-necked garlics were the original garlics and the soft-necked ones were developed or cultivated over the centuries by growers from the original hard-necks through selection.

Allium sativum Ophioscorodon are also known as purple stripe garlics, and are usually vividly striped with purplish vertical stripes decorating the bulb wrappers. In between the purple stripes, their bulb wrappers are usually very white and thick. Some sub-varieties are even heavily splotched with purple. Coloration is affected by growing conditions, particularly weather and sometimes they are strongly colored and at other times more white than purple.

Allium sativum Sativum (Soft-necked garlic) is also known as Artichoke Garlic, and is seen most in the supermarkets. They have many cloves, usually somewhere between 12 and 20, with lots of smaller internal cloves. These are a favorite among people who want to use only a very small amount of garlic in a dish (although I can't imagine why).

A third group of garlic varieties are called Silverskin garlics, which are usually the longest storing of all garlics and have a soft pliable neck that lends itself to braiding and holds up over time better than the artichokes whose necks tend to deteriorate earlier than the silverskins.

As indicated above, the part of the garlic most widely used is the bulb or “head.” A bulb is a transformed stem structure, which is condensed and discoid, and contains fleshy scale leaves, commonly known as “cloves.” A garlic bulb may contain only one clove, in which case it is called a single-clove head/bulb. The terminal bud in the center of the bulb gives rise to the aerial shoot that bears flowers. A cluster of adventitious roots is noticed at the base of the bulb. The outer most leaf base dries to form a cover called tunic or “skin.” A garlic clove has two ends, conventionally referred as the tip and the base. The tip end is the stem end of the clove, while the base end is the root end. Hereinafter these two ends are referred to the “stem end” and the “room end.”

According to one embodiment of the present invention, suitable garlic bulbs are selected, and their cloves are separated and soaked in dilute salt water (about 5%) for about half an hour. Suitable cloves are then selected and peeled to remove the tunic, resulting in individual cloves each of which has a stem end and a root end. Preferably, individual cloves for the further processing according to the present invention should have, at its largest cross-section, a cross-section diameter of at least about 5.5 cm.

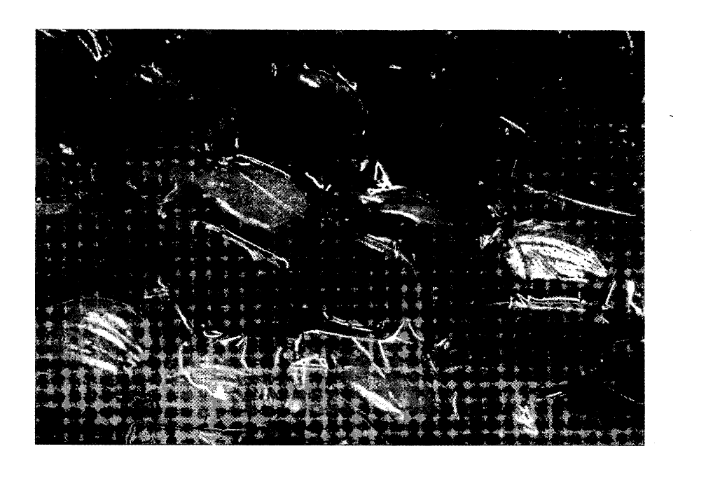

A small fragment of the tip of the stem end of the selected and peeled cloves is then cut off (see FIG. 1). Removal of the stem end of the clove prevents or minimizes the possibility that the cloves from germination or budding during storage and transportation. Although machinery for peeling and cutting may be available, hand processing and visual inspection are preferred to ensure quality and consistency.

Preferably, processing of the peeled and cut cloves are under aseptic conditions and at a temperature that is about 0° C., and more preferably.

The peeled and cut cloves are then washed in water, and decontaminated or sterilized. Preferably, the washing is with ice-cold water, and decontamination or sterilization is with a suitable chemical solution. Preferably, the chemical solution is sodium hypochlorite of about 3%. Remaining debris of the tunic is further removed by this washing process.

The washed cloves are blown dry, e.g. on a conveyor belt. The cloves may also be sorted as they are being dried. Cloves of similar size are sorted together for packaging. Damaged, undersized or odd-shaped cloves may be removed. Cloves satisfying the size and shape requirements are then packaged, preferably in a sealable plastic bag suitable for vacuum packaging. In one embodiment, each plastic bag may contain 2, 3, 4, 5 or 6 cloves.

These individual packages are very convenient to the end users because ordinarily only a very small number cloves would be needed per use in the kitchen. The end user need only to break seal of the packages to be used immediately, without having to worry about storing further garlic cloves whose package seal is broken. FIG. 1 shows an example of packages containing two cloves each.

The most important points of packaging are to protect the garlic cloves against dehydration, oxidation, and contamination: therefore, the packaging materials must be suitable in order to withstand the very low temperature encountered during frozen storage.

In a preferred embodiment, the plastic bags are made of a plastic, preferably p polyethylene with a thickness of 0.05 to 0.1 mm.

Preferably, before sealing the plastic bags containing the processed and ready-to-use garlic cloves, the cloves are cooled at about −1.0 to −3.0° C., preferably around −1.5° C. for one day, or about 24 hours.

The bags are then sealed under vacuum. In one embodiment, the unsealed bags are exposed to a pressure of 1.8 atmospheric pressure, and then sealed under pressure. The process drives air out of the bag and upon sealing, the contents of the bag are under a certain degrees of vacuum.

The packaged and sealed garlic cloves are sampled to determine their microbial or bacterial counts, using methods well-known to those skilled in the art. Acceptable bacterial counts is not more that 5,000 cfu/g, of which 0% is E. coli.

Once determined to be acceptable, the packaged and sealed garlic cloves are ready to be stored, shipped and sold to end users. Preferably, storage and transportation should be at a temperature at about 27.5-40° F., preferably at 29-31° F.

What is claimed is:

1. A method for processing and packaging garlic, the method comprising:
a. selecting a garlic bulb comprising at least one clove, wherein the clove is contained within a membranous tunic, and has a stem end and a root end;
b. removing the tunic from the glove thereon, to obtain a peeled garlic clove;
c. cutting off a small fragment of the stem end of the clove;
d. washing the peeled clove;
e. surface-sterilizing the peeled clove;
f. packaging the peeled clove in a plastic bag; and
g. sealing the bag under vacuum.

2. The method according to claim 1, wherein prior to step b, the clove is soaked in dilute salt water for about half an hour.

3. The method according to claim 1, wherein steps c-f are performed in under controlled temperature and controlled humidity conditions.

4. The method according to claim 3, wherein the controlled temperature is at or below 0° C.

5. The method according to claim 1, wherein the clove at its widest portion has a cross-section diameter of 5.5 cm or more.

6. The method according to claim 1, wherein the washing in step d is with ice cold water.

7. The method according to claim 1, wherein the surface-sterilizing in step e is with a solution of sodium hypochlorite.

8. The method according to claim 1, wherein after step e the peeled clove is dried via blow-drying.

9. The method according to claim 1, wherein 2, 3, 4, 5, or 6 cloves are packed in one plastic bag.

10. The method according to claim 1, wherein the plastic bag has a wall thickness of between about 0.05 to about 0.1 mm.

11. The method according to claim 1, wherein the plastic bag has a wall thickness of about 0.06 mm.

12. The method according to claim 1, wherein the plastic is sealed via exposing unsealed plastic bags containing the peeled garlic cloves to a pressure of 1.8 atmospheric pressures.

13. A method according to claim 1, further comprising,
a. sampling the peeled garlic clove in the sealed bag for microbial counts, to ensure that bacterial counts from the peeled garlic clove is not more than 5000 cfu/gram garlic, and that E. coli count is not more that 0 cfu/gram garlic.

14. A method for storing and transporting garlic, the method comprising processing and packaging garlic cloves according to claim 1, and storing or transporting the vacuum-sealed plastic bag containing the peeled garlic cloves at a temperature between about 27.5-40° F.

15. The method according to claim 14, wherein the temperature is between about 29-31° F.

16. Processed garlic clove in a vacuum packaged plastic bag, wherein the garlic clove is processed according to the method of claim 1, and has a bacterial count of not more than 5000 cfu/gram garlic, and an E. Coli count of not more that 0 cfu/gram garlic.

17. Processed garlic clove according to claim 16, wherein there are 2, 3, 4, 5, or 6 cloves per plastic bag.
